(19) United States
(12) Patent Application Publication
(10) Pub. No.: US 2018/0343449 A1
(43) Pub. Date: Nov. 29, 2018

(54) APPLICATION SPECIFIC FILTERS FOR HIGH-QUALITY VIDEO PLAYBACK

(71) Applicant: ATI Technologies ULC, Markham (CA)

(72) Inventors: Ihab Amer, Stouffville (CA); Gabor Sines, Toronto (CA); Boris Ivanovic, Richmond Hill (CA)

(21) Appl. No.: 15/606,851

(22) Filed: May 26, 2017

(51) Int. Cl. H04N 19/117; G06T 5/00; H04N 19/42; H04N 19/85; H04N 19/172; H04N 19/136; H04N 19/44

(52) U.S. Cl. CPC H04N 19/117; G06T 5/002; H04N 19/42; H04N 19/44; H04N 19/172; H04N 19/136; H04N 19/85

(57) ABSTRACT

Systems, apparatuses, and methods for adaptive use-case based filtering of compressed video streams are disclosed. In one embodiment, a system includes at least a display and a processor coupled to at least one memory device. The system is configured to receive a compressed video stream. For each received frame of the compressed video stream, the system decompresses the compressed video frame into an unfiltered frame. Then, the system can utilize a first filter to filter the unfiltered frame to generate a filtered frame. In one embodiment, the first filter is a de-blocking filter (DBF) combined with a sample adaptive offset (SAO) filter. Also, in this embodiment, the first filter is compliant with a video compression standard. The unfiltered frame and the filtered frame are provided as inputs to a second filter which performs a use-case specific de-noising of the inputs to generate a de-noised frame with reduced artifacts.

### BACKGROUND

### Description of the Related Art

The bandwidth requirements of digital video streaming continue to grow with time. Various applications benefit from video compression which requires less storage space for archived video information and/or less bandwidth for the transmission of the video information. Accordingly, various techniques to improve the quality and accessibility of the digital video have being developed. An example of such a technique is H.264 which is a video compression standard, or codec, proposed by the Joint Video Team (JVT). The majority of today's multimedia-enabled digital devices incorporate digital video codec's that conform to the H.264 standard.

The High Efficiency Video Coding (HEVC) is another video compression standard which followed H.264. HEVC specifies two loop filters that are applied sequentially, with the deblocking filter (DBF) applied first and the sample adaptive offset (SAO) filter applied second. Both loop filters are applied in the inter-picture prediction loop, with the filtered image stored in a decoded picture buffer as a potential reference for inter-picture prediction. However, in many cases for different types of video streaming applications, significant amounts of visual artifacts can remain after the DBF and SAO filters are applied to decompressed video frames.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a system for encoding and decoding a video stream.

FIG. 2 is a block diagram of one embodiment of a portion of a decoder.

FIG. 3 is a block diagram of one embodiment of an application specific de-noising filter.

FIG. 4 is a block diagram of one embodiment of a technique for generating the absolute value between filtered and unfiltered frames.

FIG. 5 is a generalized flow diagram illustrating one embodiment of a method for achieving improved artifact reduction when decoding compressed video frames.

FIG. 6 is a generalized flow diagram illustrating another embodiment of a method for implementing a use-case specific filter.

FIG. 7 is a generalized flow diagram illustrating one embodiment of a method for processing filtered and unfiltered frames with an application specific de-noising filter.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for adaptive use-case based filtering of video streams are disclosed herein. In one embodiment, a system includes at least a display and a processor coupled to at least one memory device. In one embodiment, the system is configured to receive a compressed video stream. For each received frame of the compressed video stream, the system decompresses the compressed video frame into a raw, unfiltered frame. Then, the system utilizes a first filter to filter the raw, unfiltered frame into a filtered frame. In one embodiment, the first filter is a de-blocking filter combined with a sample adaptive offset (SAO) filter. Also, in this embodiment, the first filter is compliant with a video compression standard. In one embodiment, the filtered frame is utilized as a reference frame for an in-loop filter.

Next, the system provides the unfiltered frame and the filtered frame to a second filter. In one embodiment, the second filter is a programmable filter that is customized for the specific use case of the compressed video stream. For example, use cases include, but are not limited to, screen content, videoconferencing, gaming, video streaming, cloud gaming, and others. The second filter filters the unfiltered frame and the filtered frame to generate a de-noised frame. After some additional post-processing, the system drives the de-noised frame to a display.

In one embodiment, the system receives a first compressed video stream. In one embodiment, the system is configured to determine the use case of the first compressed video stream. In one embodiment, the system receives an indication specifying the type of use case of the first compressed video stream. In another embodiment, the system analyzes the first compressed video stream to determine the type of use case. If the system determines that the first compressed video stream corresponds to a first use case, then the system programs the second filter with a first set of parameters customized to the first use case. Then, the system utilizes the second filter, programmed with the first set of parameters, to filter and de-noise frames of the first compressed video stream before driving the frames to the display.

At a later point in time, the system receives a second compressed video stream. If the system determines that the second compressed video stream corresponds to a second use case, then the system programs the second filter with a second set of parameters customized to the second use case. Then, the system utilizes the second filter, programmed with the second set of parameters, to filter and de-noise frames of the second compressed video stream before driving the frames to the display.

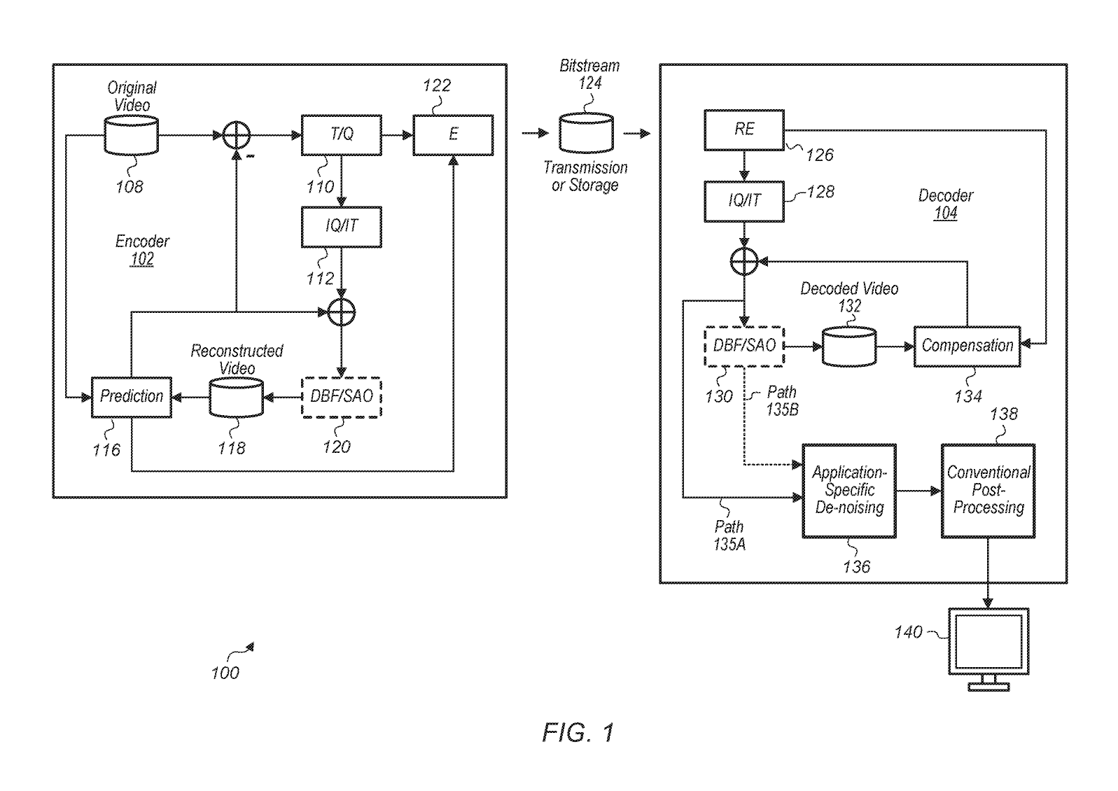

Referring now to FIG. 1, a block diagram of one embodiment of a system 100 for encoding and decoding a video stream is shown. In one embodiment, encoder 102 and decoder 104 are part of the same system 100. In another embodiment, encoder 102 and decoder 104 are part of separate systems. In one embodiment, encoder 102 is configured to compress original video 108. Encoder 102 includes transform and quantization block 110, entropy block 122, inverse quantization and inverse transform block 112, prediction module 116, and combined deblocking filter (DBF) and sample adaptive offset (SAO) filter 120. Reconstructed video 118 is provided as an input into prediction module 116. In other embodiments, encoder 102 can include other components and/or be structured differently. The output of encoder 102 is bitstream 124 which can be stored or transmitted to decoder 104.

When decoder 104 receives bitstream 124, reverse entropy block 126 can process the bitstream 124 followed by inverse quantization and inverse transform block 128. Then, the output of inverse quantization and inverse transform block 128 is combined with the output of compensation block 134. It is noted that blocks 126, 128, and 134 can be referred to as a “decompression unit”. In other embodiments, the decompression unit can include other blocks and/or be structured differently. Deblocking filter (DBF) and sample adaptive offset (SAO) filter 130 is configured to process the raw, unfiltered frames so as to generate decoded video 132. In one embodiment, DBF/SAO filter 130 reverses the filtering that was applied by DBF/SAO filter 120 in encoder 102. In some embodiments, DBF/SAO filtering can be disabled in both encoder 102 and decoder 104.

In one embodiment, there are two inputs to the application specific de-noising filter 136. These inputs are coupled to application specific de-noising filter 136 via path 135A and path 135B. The raw, unfiltered frame is conveyed to application specific de-noising filter 136 via path 135A and the filtered frame is conveyed to application specific de-noising filter 136 via path 135B. Application specific de-noising filter 136 is configured to filter one or both of these frames to generate a de-noised frame with reduced artifacts. It is noted that application specific de-noising filter 136 can also be referred to as a “deblocking filter”, an “artifact reduction filter”, or other similar terms.

The de-noised frame is then conveyed from application specific de-noising filter 136 to conventional post-processing block 138. In one embodiment, conventional post-processing block 138 performs resizing and a color space conversion to match the characteristics of display 140. In other embodiments, conventional post-processing block 138 can perform other types of post-processing operations on the de-noised frame. Then, the frame is driven from conventional post-processing block 138 to display 140. This process can be repeated for subsequent frames of the received video stream.

In one embodiment, application specific de-noising filter 136 is configured to utilize a de-noising algorithm that is customized for the specific application which generated the received video stream. Examples of different applications which can be utilized to generate a video stream include video conferencing, screen content (e.g., remote computer desktop access, real-time screen sharing), gaming, movie making, video streaming, cloud gaming, and others. For each of these different types of applications, application specific de-noising filter 136 is configured to utilize a filtering and/or de-noising algorithm that is adapted to the specific application for reducing visual artifacts.

In one embodiment, application specific de-noising filter 136 utilizes a machine learning algorithm to perform filtering and/or de-noising of the received video stream. In one embodiment, application specific de-noising filter 136 is implemented using a trained neural network. In other embodiments, application specific de-noising filter 136 can be implementing using other types of machine learning algorithms.

Depending on the embodiment, decoder 104 can be implemented using any suitable combination of hardware and/or software. For example, decoder 104 can be implemented in a computing system utilizing a central processing unit (CPU), graphics processing unit (GPU), digital signal processor (DSP), field programmable gate array (FPGA), application specific integrated circuit (ASIC), or any other suitable hardware devices. The hardware device(s) can be coupled to one or more memory device which include program instructions executable by the hardware device(s).

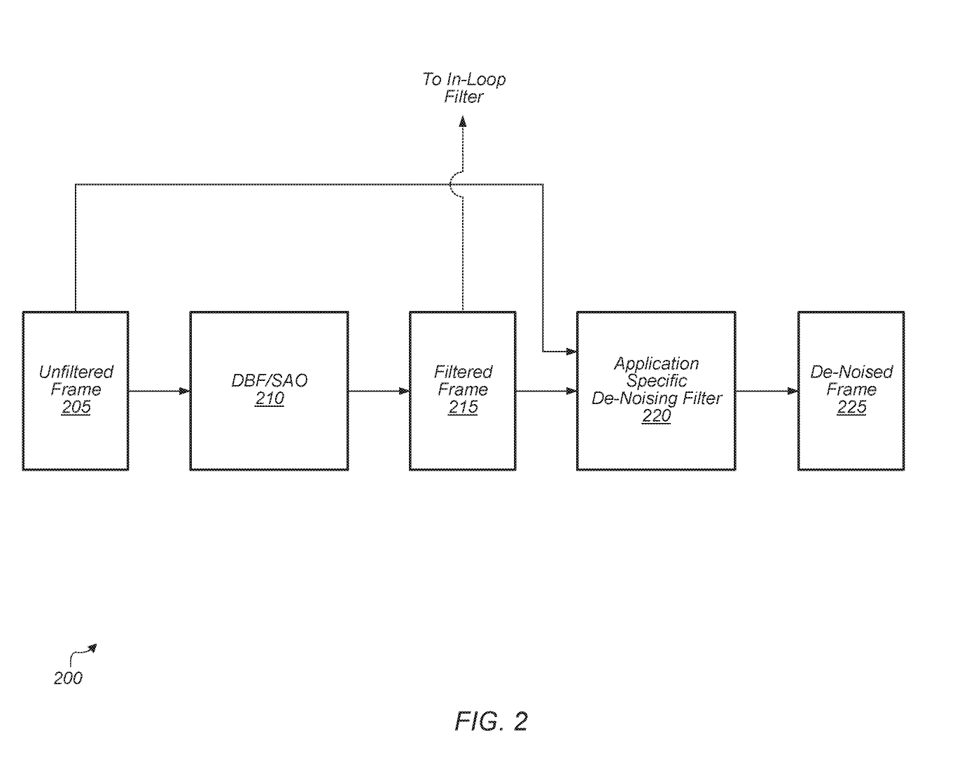

Turning now to FIG. 2, a block diagram of one embodiment of a portion of a decoder 200 is shown. Decoder 200 receives a frame of a compressed video stream, and decoder 200 is configured to decompress the frame to generate unfiltered frame 205. In one embodiment, the compressed video stream is compliant with a video compression standard (e.g., HEVC). In this embodiment, the compressed video stream is encoded with a DBF/SAO filter. Accordingly, decoder 200 includes DBF/SAO filter 210 to reverse the DBF/SAO filtering performed at the encoder so as to create filtered frame 215 from unfiltered frame 205. Filtered frame 215 can also be referred to as a “reference frame”. This reference frame can be conveyed to an in-loop filter (not shown) of decoder 200 to be used for the generation of subsequent frames.

Both unfiltered frame 205 and filtered frame 215 are conveyed to application specific de-noising filter 220. Application specific de-noising filter 220 utilizes one or both of the unfiltered frame 205 and filtered frame 215 and performs de-noising filtering on the input(s) to generate de-noised frame 225. The term “de-noised frame” is defined as the output of an application specific de-noising filter. De-noised frame 225 includes fewer visual artifacts as compared to unfiltered frame 205 and filtered frame 215.

In one embodiment, application specific de-noising filter 220 calculates the difference between the pixels of unfiltered frame 205 and filtered frame 215. Then, application specific de-noising filter 220 utilizes the difference values for the pixels to determine how to filter unfiltered frame 205 and/or filtered frame 215. In one embodiment, application specific de-noising filter 220 determines the application which generated the frames of the received compressed video stream, and then application specific de-noising filter 220 performs a filtering that is customized for the specific application.

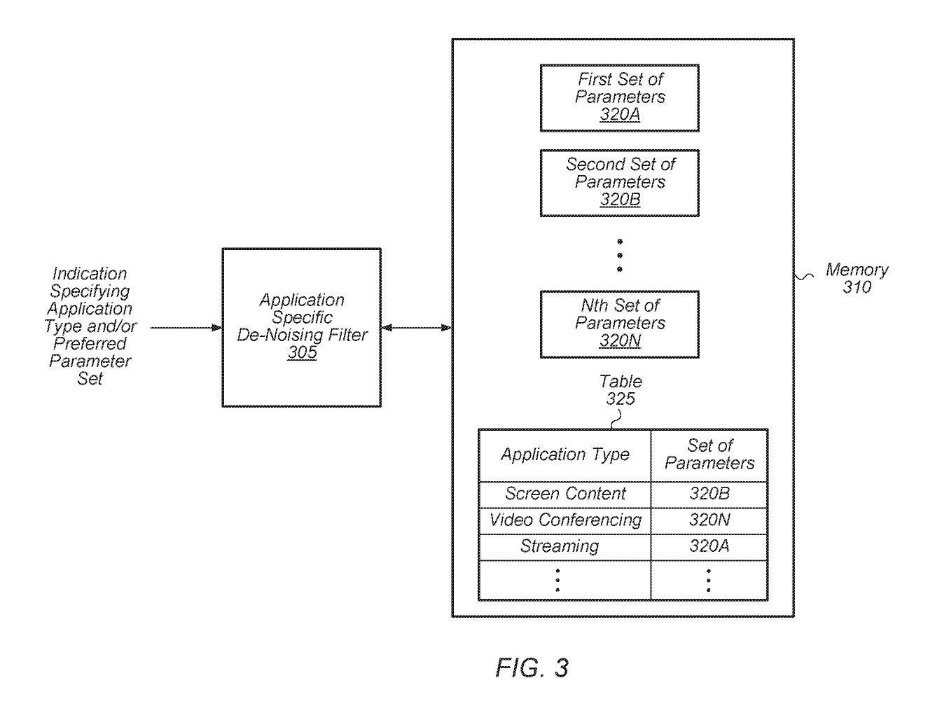

Referring now to FIG. 3, a block diagram of one embodiment of an application specific de-noising filter 305 is shown. In one embodiment, application specific de-noising filter 305 is coupled to memory 310. Memory 310 is representative of any type of memory device or collection of storage elements. When application specific de-noising filter 305 receives a compressed video stream, application specific de-noising filter 305 is configured to determine or receive an indication of the application (i.e., use case) of the compressed video stream. In one embodiment, application specific de-noising filter 305 receives an indication of the type of the application. The indication can be included within a header of the compressed video stream, or the indication can be a separate signal or data sent on a separate channel from the compressed video stream. In another embodiment, application specific de-noising filter 305 analyzes the compressed video stream to determine the type of application which generated the compressed video stream. In other embodiments, other techniques for determining the type of application which generated the compressed video stream can be utilized.

In one embodiment, application specific de-noising filter 305 queries table 325 with the application type to determine which set of parameters to utilize when performing the de-noising filtering of the received frames of the compressed video stream. For example, if the application type is screen content, then application specific de-noising filter 305 will retrieve second set of parameters 320B to utilize for programming the de-noising filtering elements. Alternatively, if the application type is video conferencing, then application specific de-noising filter 305 will retrieve Nth set of parameters 320N, if the application type is streaming, then application specific de-noising filter 305 will retrieve first set of parameters 320A, and so on. In one embodiment, application specific de-noising filter 305 includes a machine learning model, and the set of parameters retrieved from memory 310 are utilized to program the machine learning model for performing the de-noising filtering. For example, the machine learning model can be a support vector machine, a regression model, a neural network, or other type of model. Depending on the embodiment, the machine learning model can be trained or untrained. In other embodiments, application specific de-noising filter 305 can utilize other types of filters for performing de-noising of input video streams.

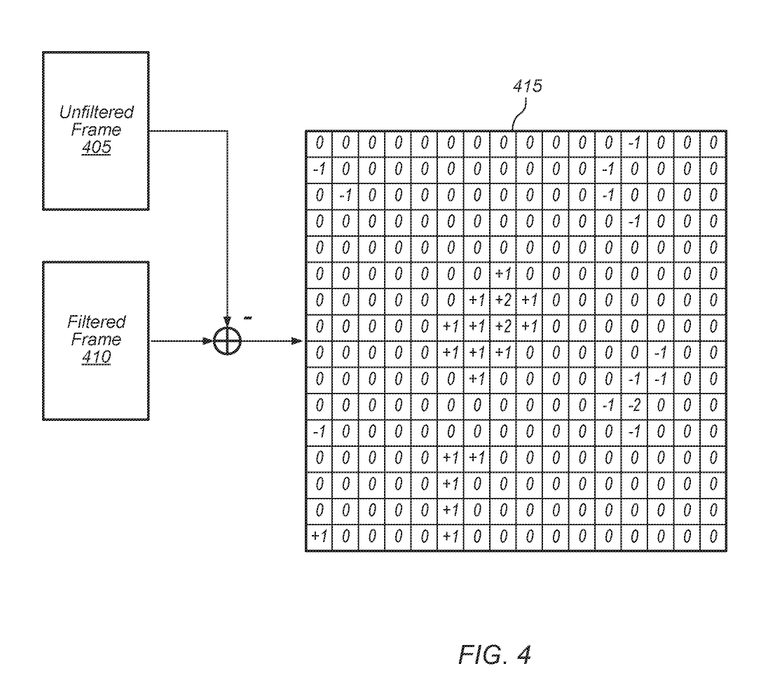

Turning now to FIG. 4, a block diagram of one embodiment of generating the absolute value between filtered and unfiltered frames is shown. In one embodiment, an application specific de-noising filter (e.g., application specific de-noising filter 136 of FIG. 1) receives unfiltered frame 405 and filtered frame 410. In one embodiment, filtered frame 410 is generated by a combined deblocking filter (DBF) and sample adaptive offset (SAO) filter which is compliant with a video compressed standard. Unfiltered frame 405 represents the input to the DBF/SAO filter. Both unfiltered frame 405 and filtered frame 410 are provided as inputs to the application specific de-noising filter.

In one embodiment, the application specific de-noising filter calculates the differences between unfiltered frame 405 and filtered frame 410 for each pixel of the frames. The difference frame 415 is shown in FIG. 4 as one example of the differences for the pixels of the frames. The values shown in difference frame 415 are merely examples and are intended to represent how each pixel can be assigned a value which is equal to the difference between the corresponding pixels in unfiltered frame 405 and filtered frame 410. In one embodiment, the application specific de-noising filter utilizes the values in difference frame 415 to perform the de-noising filtering of unfiltered frame 405 and filtered frame. The non-zero values in difference frame 415 indicate which pixel values were changed by the DBF/SAO filter.

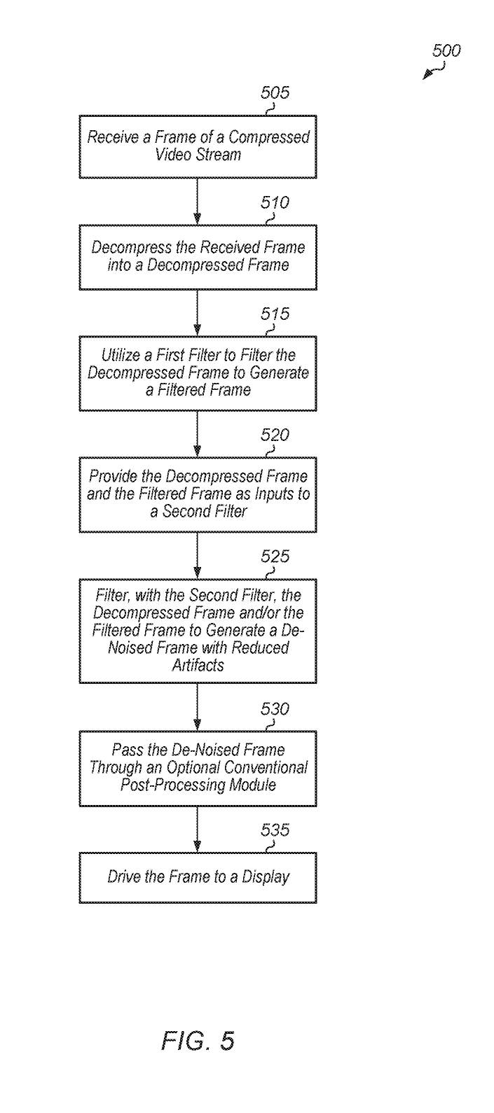

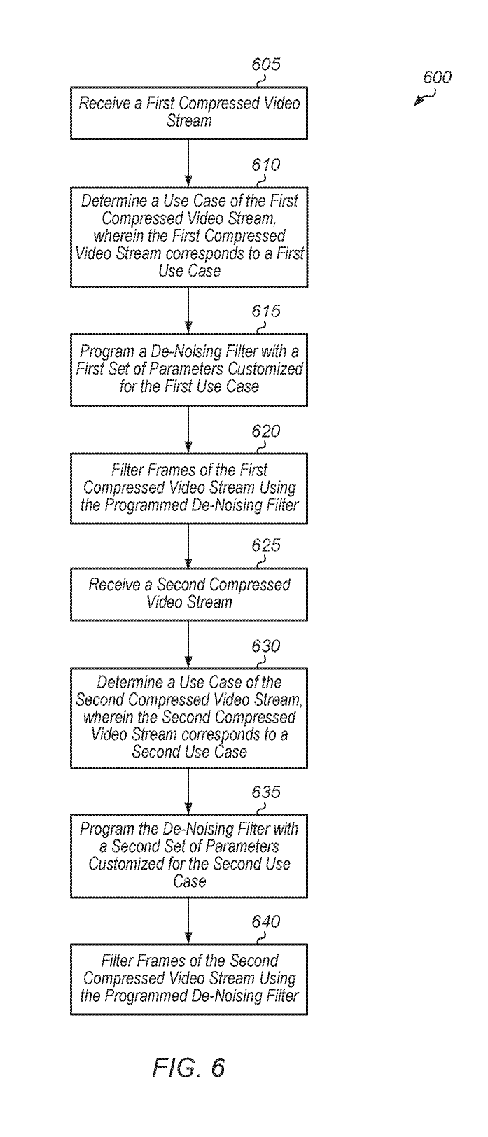

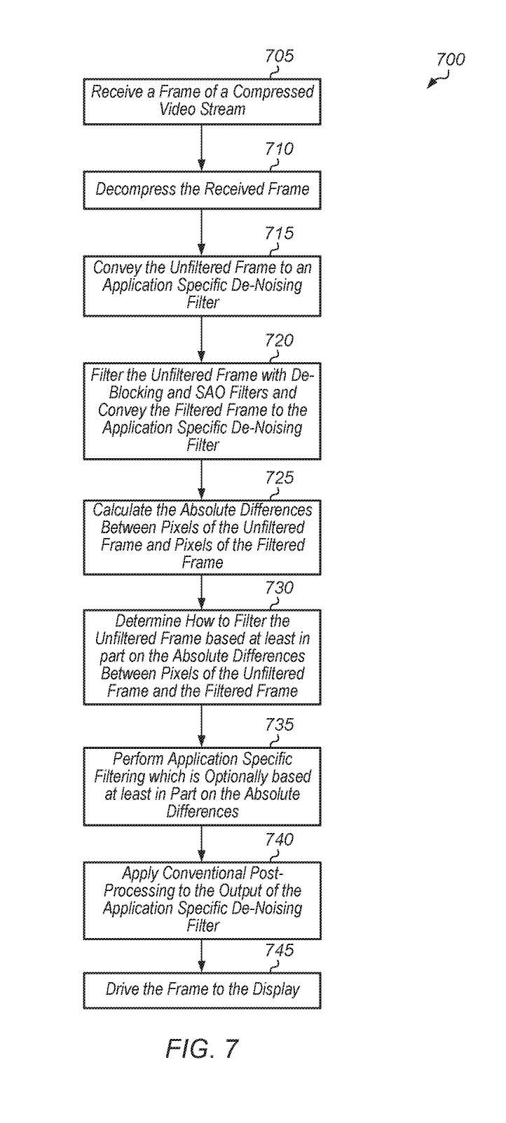

Referring now to FIG. 5, one embodiment of a method 500 for achieving improved artifact reduction when decoding compressed video frames is shown. For purposes of discussion, the steps in this embodiment and those of FIGS. 6-7 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

A decoder receives a frame of a compressed video stream (block 505). In one embodiment, the decoder is implemented on a system with at least one processor coupled to at least one memory device. In one embodiment, the video stream is compressed in accordance with a video compression standard (e.g., HEVC). The decoder decompresses the received frame to generate a decompressed frame (block 510). Next, the decoder utilizes a first filter to filter the decompressed frame to generate a filtered frame (block 515). In one embodiment, the first filter performs de-blocking and sample adaptive offset filtering. In this embodiment, the first filter is also compliant with a video compression standard.

Then, the decoder provides the decompressed frame and the filtered frame as inputs to a second filter (block 520). Next, the second filter filters the decompressed frame and/or the filtered frame to generate a de-noised frame with reduced artifacts (block 525). Then, the de-noised frame is passed through an optional conventional post-processing module (block 530). In one embodiment, the conventional post-processing module resizes and performs a color space conversion on the de-noised frame. Next, the frame is driven to a display (block 535). After block 535, method 500 ends.

Turning now to FIG. 6, one embodiment of a method 600 for implementing a use-case specific filter is shown. A decoder receives a first compressed video stream (block 605). Next, the decoder determines a use case of the first compressed video stream, wherein the first compressed video stream corresponds to a first use case (block 610). Next, the decoder programs a de-noising filter with a first set of parameters customized for the first use case (block 615). Then, the decoder filters frames of the first compressed video stream using the programmed de-noising filter (block 620).

At a later point in time, the decoder receives a second compressed video stream (block 625). Generally speaking, the decoder can receive any number of different compressed video streams. Next, the decoder determines a use case of the second compressed video stream, wherein the second compressed video stream corresponds to a second use case (block 630). It is assumed for the purposes of this discussion that the second use case is different from the first use case. Next, the decoder programs the de-noising filter with a second set of parameters customized for the second use case (block 635). It is assumed for the purposes of this discussion that the second set of parameters are different from the first set of parameters. Then, the decoder filters frames of the second compressed video stream using the programmed de-noising filter (block 640). After block 640, method 600 ends. It is noted that method 600 can be repeated any number of times for any number of different compressed video streams that are received by the decoder.

Referring now to FIG. 7, one embodiment of a method 700 for processing filtered and unfiltered frames with an application specific de-noising filter is shown. A decoder receives a frame of a compressed video stream (block 705). The decoder decompresses the received frame (block 710). This decompressed frame, prior to being processed by a de-blocking filter, is referred to as an unfiltered frame. The decoder conveys the unfiltered frame to an application specific de-noising filter (block 715). Also, the decoder filters the frame with de-blocking and SAO filters and then conveys the filtered frame to the application specific de-noising filter (block 720). Then, the application specific de-noising filter calculates the absolute differences between pixels of the unfiltered frame and pixels of the filtered frame (block 725).

Next, the application specific de-noising filter determines how to filter the unfiltered frame based at least in part on the absolute differences between the unfiltered frame and the filtered frame (block 730). Then, application specific de-noising filter performs application specific filtering which is optionally based at least in part on the absolute differences between the unfiltered frame and the filtered frame (block 735). Next, conventional post-processing (e.g., resizing, color space conversion) is applied to the output of the application specific de-noising filter (block 740). Then, the frame is driven to the display (block 745). After block 745, method 700 ends. Alternatively, method 700 can be repeated for the next frame of the compressed video stream.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a first filter;
a second filter; and
a display;
wherein the system is configured to:
receive a frame of a first compressed video stream;
decompress the frame to generate a decompressed frame;
filter the decompressed frame with the first filter to generate a filtered frame;
receive the decompressed frame and the filtered frame at the second filter;
process, with the second filter, the decompressed frame and the filtered frame to generate a de-noised frame; and
drive the de-noised frame to the display.

2. The system as recited in claim 1, wherein the first filter is compliant with a video compression standard.

3. The system as recited in claim 1, wherein the second filter is a programmable filter.

4. The system as recited in claim 1, wherein the second filter generates the de-noised frame based at least in part on differences between pixels of the decompressed frame and corresponding pixels of the filtered frame.

5. The system as recited in claim 1, wherein the system is further configured to:
determine a use case of the first compressed video stream, wherein the first compressed video stream corresponds to a first use case;
program the second filter with a first set of parameters customized for the first use case;
receive a second compressed video stream;
determine a use case of the second compressed video stream, wherein the second compressed video stream corresponds to a second use case;
program the second filter with a second set of parameters customized for the second use case, wherein the second set of parameters are different from the first set of parameters, and wherein the second use case is different from the first use case.

6. The system as recited in claim 1, wherein the compressed video data is compliant with a video compression standard.

7. The system as recited in claim 1, wherein the second filter is configured to calculate differences for pixels of the decompressed frame and corresponding pixels of the filtered frame.

8. A method comprising:
receiving and decompressing a frame of a first compressed video stream to generate a decompressed frame;
filtering, with a first filter, the decompressed frame to generate a filtered frame;
receiving the decompressed frame and the filtered frame at a second filter; and
processing, with the second filter, the decompressed frame and filtered frame to generate a de-noised frame.

9. The method as recited in claim 8, wherein the first filter is compliant with a video compression standard.

10. The method as recited in claim 8, wherein the second filter is a programmable filter.

11. The method as recited in claim 8, wherein the second filter generates the de-noised frame based at least in part on differences between pixels of the decompressed frame and corresponding pixels of the filtered frame.

12. The method as recited in claim 8, further comprising:
determining a use case of the first compressed video stream, wherein the first compressed video stream corresponds to a first use case;
programming the second filter with a first set of parameters customized for the first use case;
receiving a second compressed video stream;
determining a use case of the second compressed video stream, wherein the second compressed video stream corresponds to a second use case;
programming the second filter with a second set of parameters customized for the second use case, wherein the second set of parameters are different from the first set of parameters, and wherein the second use case is different from the first use case.

13. The method as recited in claim 8, wherein the compressed video data is compliant with a video compression standard.

14. The method as recited in claim 8, further comprising calculating, by the second filter, differences for pixels of the decompressed frame and corresponding pixels of the filtered frame.

15. An apparatus comprising:
a decompression unit configured to receive and decompress a frame, of a first compressed video stream, to generate a decompressed frame;
a first filter configured to filter the decompressed frame to generate a filtered frame; and
a second filter configured to:
receive the decompressed frame and the filtered frame; and
process the decompressed frame and the filtered frame to generate a de-noised frame.

16. The apparatus as recited in claim 15, wherein the first filter is compliant with a video compression standard.

17. The apparatus as recited in claim 15, wherein the second filter is a programmable filter.

18. The apparatus as recited in claim 15, wherein the second filter generates the de-noised frame based at least in part on differences between pixels of the decompressed frame and corresponding pixels of the filtered frame.

19. The apparatus as recited in claim 15, wherein the apparatus is further configured to:
determine a use case of the first compressed video stream, wherein the first compressed video stream corresponds to a first use case;
program the second filter with a first set of parameters customized for the first use case;
receive a second compressed video stream;
determine a use case of the second compressed video stream, wherein the second compressed video stream corresponds to a second use case; program the second filter with a second set of parameters customized for the second use case, wherein the second set of parameters are different from the first set of parameters, and wherein the second use case is different from the first use case.

20. The apparatus as recited in claim 15, wherein the compressed video data is compliant with a video compression standard.
